(19) United States
(12) Patent Application Publication
(10) Pub. No.: US 2012/0236319 A1
(43) Pub. Date: Sep. 20, 2012

(54) OBJECT DETECTING APPARATUS

(75) Inventors: Toshiyuki Gotou, Nukata-gun (JP); Toshiyuki Konishi, Anjo-city (JP)

(73) Assignee: DENSO CORPORATION, Kariya-city (JP)

(21) Appl. No.: 13/418,652

(22) Filed: Mar. 13, 2012

(30) Foreign Application Priority Data
Mar. 15, 2011 (JP) 2011-056796

(51) Int. Cl. G01B 11/14

(52) U.S. Cl. 356/614

(57) ABSTRACT

An object detecting apparatus may include a laser sensor and a contamination detection unit. The laser sensor emits a laser beam through an optical window to scan in a plane by changing an emission direction of the laser beam, and receives a reflected beam through the optical window from an object positioned in the plane. The contamination detection unit detects contamination of the optical window by positioning the emission direction of the laser beam in a downward direction towards a pavement surface. The contamination detection unit determines whether or not the optical window is contaminated based on whether the reflected laser beam from the pavement surface is received.

### CROSS REFERENCE TO RELATED APPLICATION

The present application is based on and claims the benefit of priority of Japanese Patent Application No. 2011-56796, filed on Mar. 15, 2011, the disclosure of which is incorporated herein by reference.

### TECHNICAL FIELD

The present disclosure generally relates to an object detecting apparatus detecting an object around a vehicle.

### BACKGROUND

Conventionally, a door proximity scan apparatus for detecting an object, which may interfere with the door, is known. For example, in Japanese Patent Laid-Open No. 2010-101150 (JP '150) (US Publication No. 2010/0076651) an apparatus is disclosed that emits a laser beam from a position around a door rotation axis toward a plane that has a predetermined angle against an outer surface of the door of a vehicle. By receiving a reflection of the laser beam reflected from an obstacle, such an apparatus detects the obstacle within proximity of the door.

The apparatus disclosed in JP '150 may have dirt or foreign matter on an optical window, which may obscure the scanning capability of the apparatus. As a result, an obstacle around the door may not be detected and the vehicle door may collide with such obstacle.

If a dedicated photo-sensitive element is disposed in the apparatus for receiving an internal reflection of the laser beam reflected by dirt on the optical window, separately from a photo-sensitive element for receiving a reflection of the laser beam from the obstacle, such dirt on the optical window may properly be detected. However, such a configuration of the apparatus to have a separate photo-sensitive element leads to an increase in production cost of the apparatus.

### SUMMARY

In an aspect of the present disclosure, an object detecting apparatus for detecting an object around a vehicle may include a laser sensor and a contamination detection unit. The laser sensor may emit a laser beam through an optical window to scan in a plane by changing an emission direction of the laser beam. In addition, the laser sensor may further receive a reflected laser beam through the optical window from an object positioned in the plane.

The contamination detection unit detects contamination of the optical window, such as dirt and foreign particles that may affect the operation of the object detecting apparatus. The contamination detection unit controls the emission direction of the laser beam to emit the laser beam in a downward direction towards a pavement surface, such that the laser beam is substantially perpendicular to the pavement surface, and determines whether or not the optical window is contaminated based on whether the reflected laser beam from the pavement surface is received.

Such a configuration enables the object detecting apparatus to detect the condition of the optical window (i.e. is the optical window contaminated). By changing the direction of the laser beam, such that the laser beam is emitted in a downward direction, whether or not the optical window is contaminated by foreign particles (dirt, water spots, or the like) can be determined by whether the reflection of the laser beam from the surface of the pavement is detected.

Further, the object detecting apparatus may be disposed in a vehicle that is equipped with a door open-close mechanism for automatically opening and closing a vehicle door. The laser sensor of the object detecting apparatus detects an object that may interfere with the door when the door is opened.

As described above, the apparatus may be disposed in a vehicle that is equipped with a door open-close mechanism for automatically opening and closing a vehicle door.

### BRIEF DESCRIPTION OF THE DRAWINGS

Objects, features, and advantages of the present disclosure will become more apparent from the following detailed description and the accompanying drawings, in which:

FIG. 1 is an illustration of an in-vehicle installation condition of a laser sensor that is formed as a part of an object detecting apparatus of the present disclosure;

FIG. 2 is a front view of the laser sensor of the present disclosure;

FIG. 3 is an illustration of an optical system of the laser sensor of the present disclosure;

FIG. 4 is an illustration of an emission direction of a laser beam from the laser sensor of the present disclosure;

FIG. 5 is a block diagram of the object detecting apparatus of the present disclosure;

FIG. 6 is a flowchart of a process performed by a swing door ECU of the present disclosure;

FIG. 7 is a flowchart of a contamination detection process of the present disclosure; and

FIG. 8 is a flowchart of an obstacle detection process of the present disclosure.

### DETAILED DESCRIPTION

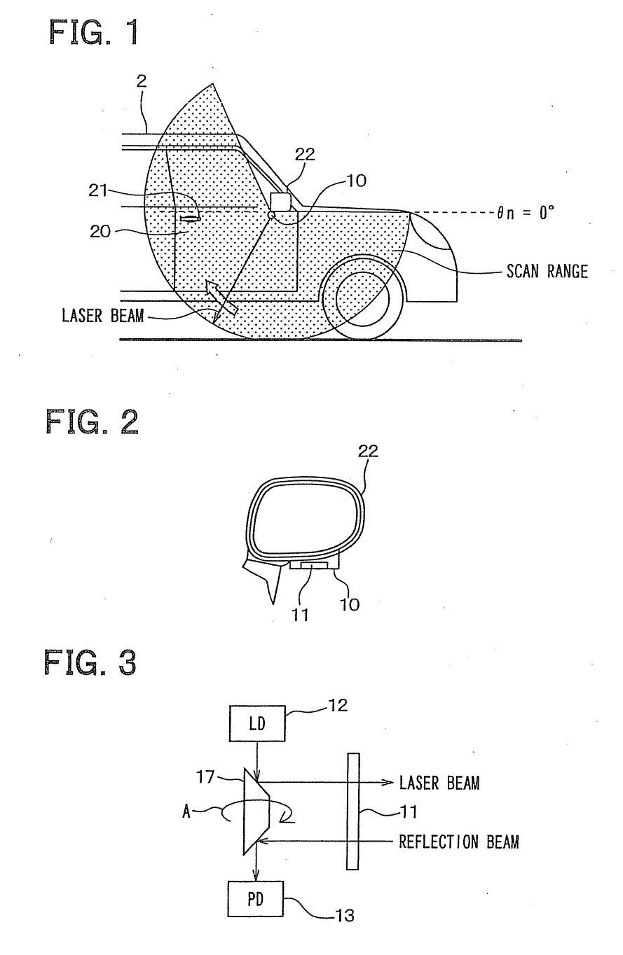

With reference to FIGS. 1 and 2, a vehicle 2 includes a vehicle door 20 and a laser sensor 10. The vehicle door 20 may include an open-close control apparatus to automatically open and close the vehicle door 20 according to a touch operation of a door open switch 21 performed by a user (i.e., a door open control). The laser sensor 10 is part of an object detecting apparatus to detect an object that may come in contact with a surface of the vehicle door 20. Specifically, the object detecting apparatus may be disposed to control the open-close control apparatus of vehicle door 20, to detect objects that may come into contact with vehicle door 20, as vehicle door 20 opens and closes.

The laser sensor 10 is positioned on a door mirror 22 of the vehicle 2, such as on a lower portion of the door mirror 22 (FIG. 2). The laser sensor 10 has an optical window 11. The laser sensor 10 emits a laser beam through the optical window 11, and receives a reflected beam through the optical window 11. The laser sensor 10 is configured to scan for an obstacle adjacent to the vehicle door 20 in a scan range (i.e. scanning plane) that includes a downward direction (FIG. 1). More practically, the laser beam emission direction from the laser sensor 10 is rotated (i.e. changed) to scan for an obstacle in the scan range, and a reflection from the obstacle is received by the laser sensor to detect the obstacle in the scan range outside of the vehicle door 20.

With reference now including FIG. 3, the laser sensor 10 includes a laser diode (LD) 12 for emitting a laser beam, a photodiode (PD) 13 for receiving the laser beam reflected by an object (i.e. a reflected beam), and a mirror 17. The mirror 17 directs the laser beam from the LD 12 outward through the optical window 11 and redirects the laser beam reflected by an object (i.e., a reflected beam) from the optical window 11 toward the PD 13. The mirror 17 is rotated in a direction indicated by an arrow A in FIG. 3. By rotating the mirror 17, an obstacle just outside of the vehicle door 20 may be scanned by the laser beam (FIG. 1).

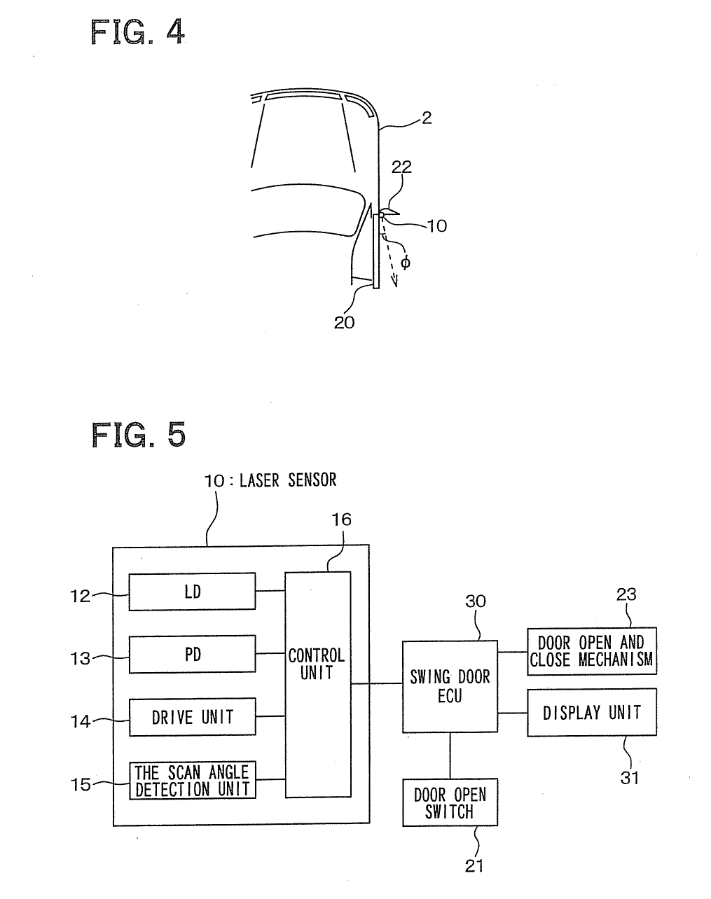

With reference to FIG. 4, the laser sensor 10 is disposed to emit the laser beam in a direction tilted toward a door opening direction by a rotation offset angle of φ relative to an outside surface of the vehicle door 20. By disposing the laser sensor 10 with an offset, the scan range of the laser sensor is set away from the surface of the vehicle door 20 and an object around the vehicle door 20 is detected in advance at a time of automatic control of opening the vehicle door 20.

With reference to FIG. 5, in addition to the LD 12, the PD 13, and the mirror 17, the laser 10 also includes a drive unit 14, a scan angle detection unit 15, and a control unit 16.

The control unit 16 provides a drive signal to the LD 12, and the LD 12 emits a laser beam according to the drive signal. The control unit 16 further receives an electrical signal from the PD 13, the electrical signal is based on the reflected beam received by the PD 13.

The drive unit 14 rotates the mirror 17. For example, the drive unit 14 may have a motor (not illustrated), and the motor is rotated according to a signal provided by the control unit 16. When the motor rotates, the rotational power is transmitted to a motor shaft, and a drive mechanism rotates the mirror 17 with the rotational power of the motor shaft.

The scan angle detection unit 15 outputs a scan angle signal according to a rotation angle of the mirror 17. In the present embodiment, the scan angle signal is determined with reference to a start position of the scan range, shown in FIG. 1 as θn=0 (n: natural number) degree according to the rotation angle of the mirror 17.

With continuing reference to FIG. 5, a block diagram of the object detecting apparatus in the embodiment of the present disclosure is provided. Along with the laser sensor 10, the object detecting apparatus further includes a swing door ECU 30 and a display unit 31. The swing door ECU 30 is coupled to a door open switch 21 and a door open and close mechanism 23.

The door open switch 21 is a switch operated to open or close the vehicle door 20. When the user performs a touch operation on the door open switch 21, a signal according to the user operation (i.e., the touch operation) is input from the door open switch 21 to the swing door ECU 30.

The door open and close mechanism 23 includes an open/close motor that is driven by a signal from the swing door ECU 30 and a door drive mechanism for opening and closing the vehicle door 20 according to the rotation power of a shaft of the open/close motor (not illustrated). For example, the vehicle door 20 is opened by the door open and close mechanism 23 when the open/close motor is driven in an original rotation direction according to the signal from the swing door ECU 30, and the vehicle door 20 is closed by the door open and close mechanism 23 when the open/close motor is driven in a reverse rotation direction according to the signal from the swing door ECU 30.

The swing door ECU 30 controls the door open and close mechanism 23 in order to automatically open and close of the vehicle door 20. The swing door ECU 30 includes CPU, RAM, ROM, EEPROM, an input/output circuit together with other parts as a computer, and CPU performs various processes according to a program memorized by ROM.

The display unit 31 includes a display panel such as a liquid crystal display, and displays an image according to an image signal input from the swing door ECU 30. The display unit 31 in the present embodiment is disposed in a meter panel of the vehicle 2 (not illustrated).

If the optical window 11 of the laser sensor 10 has foreign matter such as dirt or the like sticking thereon, the laser sensor 10 may not be able to properly detect an object. Specifically, with foreign matter on the optical window 11 (i.e. the optical window 11 is contaminated), the laser beam transmitted from the LD 12 through the optical window 11 and/or the laser beam reflected from an object to the optical window 11, may be intercepted by the foreign matter, thereby prohibiting detection of the obstacle. Thus, the vehicle door 20 may come in contact and hit the obstacle, which was not detected.

Based on the above, the swing door ECU 30 of the object detecting apparatus performs a contamination detection process. In the contamination detection process, the swing door ECU 30 controls the laser sensor 10 by directing the laser beam in a downward direction towards a surface of a pavement on which the vehicle is positioned (referred to as pavement surface). Specifically, the swing door ECU 30 directs the laser beam in the downward direction, so that the laser beam is substantially perpendicular with the pavement surface. The contamination detection process then determines whether the laser beam reflected by the pavement surface is received. That is, by changing the direction of the laser beam in a down-ward direction toward the pavement surface from which it is known that the laser beam is reflected from, the contamination detection process is able to determine the optical window 11 is contaminated when the reflected beam from the pavement surface is not received by the laser sensor 10.

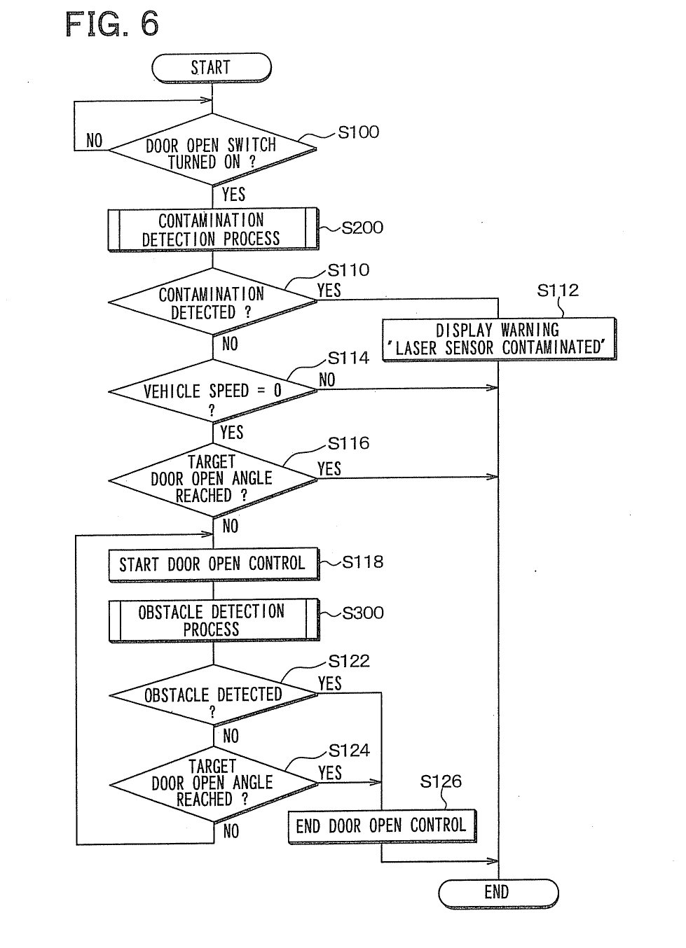

With reference to FIG. 6, a vehicle door opening process is described. The vehicle door opening process may be performed by the swing door ECU 30. The swing door ECU 30 performs the process shown in FIG. 6 periodically.

The process, in S100, determines whether the door open switch 21 is turned on. As provided above, when the user performs a touch operation of the door open switch 21, a signal according to the user operation is provided from the door open switch 21 to the swing door ECU 30, thereby indicating that the door open switch 21 is turned on.

When the signal according to the touch operation of the user from the door open switch 21 is not provided (S100: NO), the process waits for the signal by repeating the determination of S100. When the signal according to the touch operation of the user from the door open switch 21 is provided to the swing door ECU 30 (S100: YES), the swing door ECU 30 may perform the contamination detection process (S200).

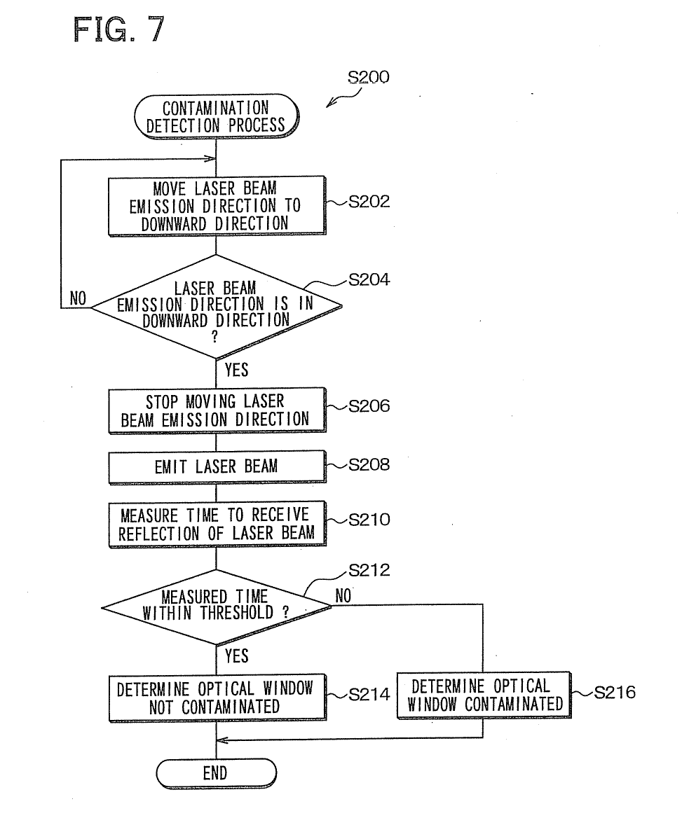

FIG. 7 shows a flowchart of the contamination detection process (S200). In S202, the swing door ECU 30 operates the laser sensor 10 to change the direction of the laser beam to a downward direction towards the pavement surface. Specifically, the swing door ECU 30 transmits a signal to the control unit 16 of the laser sensor 10 to instruct the control unit 16 to move the direction of the laser beam to the downward direction. According to the signal, the control unit 16 drives the motor of the drive unit 14 to rotate the mirror 17. The mirror 17 is rotated to direct the laser beam emitted by the LD 12 in the downward direction, thereby moving the emission direction of the laser beam.

Based on a signal output from the scan angle detection unit 15, the process, in S204, determines whether the mirror 17 is sufficiently rotated such that the emission direction of the laser beam is in the downward direction.

If the emission direction of the laser beam is not in the downward direction (S204: NO), the process repeats S202 till the emission direction of the laser beam is in the downward direction. When the mirror 17 is positioned such that the laser beam is emitted in the downward direction (S204: YES), the movement of the laser beam is stopped (S206). Specifically, the process provides a signal instructing the control unit 16 to stop driving the motor of the drive unit 14, which stops the rotation of the mirror 17, and the emission direction of the laser beam is now in the downward direction towards the pavement surface.

The process, in S209, emits the laser beam. That is, the swing door ECU 30 transmits a signal instructing the control unit 16 to emit the laser beam. The control unit 16 emits the laser beam with the brightness modulation from the LD 12. The laser beam is emitted downward toward the pavement surface.

The process, in S210, determines whether a light reception signal is output within a preset time. The control unit 16 measures the time difference between the emission of the brightness modulated laser beam from the LD 12 and the reception of the laser beam reflected by the surface, and provides the swing door ECU 30 information indicative of such time difference. In this case, the time to receive the reflection beam is identified based on the information indicative of the time difference output from the control unit 16.

The process, in S212, determines whether a reception signal is provided within the preset time (S212). The preset time defines a threshold of time difference between the emission of the laser beam from the laser sensor 10 and the reception of the reflected beam from the pavement surface. Such preset time is defined in consideration of the installation position of the laser sensor 10 (i.e., the height of the laser sensor 10 from the pavement surface) and measurement error. In other words, the preset time is different vehicle to vehicle, as a vehicle height and shape may differ from another vehicle.

When the laser beam, emitted in the downward direction from the laser sensor 10, is reflected from the pavement surface and received by the laser sensor 10, and the reception signal is provided within the preset time (S212: YES), then no contamination is detected on the optical window 11, and a flag reflective of the condition of the optical window 11 is set to 0 indicating the optical window 11 is not contaminated (i.e. condition of optical window 11 is normal). Further, according to the time difference between the emission of the laser beam in the downward direction and the reception of the reflected beam from the pavement surface, it may also be determined whether there is an obstacle vertically downward from the laser sensor 10.

When, the laser beam emitted in the downward direction from the laser sensor 10 is not received and the reception signal is not provided within the preset time (S212: NO), the process, in S216, determines that the optical window 11 is contaminated (i.e. dirt, particles, or other foreign material is on the optical window 11, and is effecting the performance of the laser sensor 10), and the flag reflective of the condition of the optical window 11 is set to 1 to indicate the optical window 11 is contaminated

From S214 or S216 of FIG. 7, the process moves to S110 of FIG. 6. In S110, the process determines whether contamination of the laser sensor 10 is detected or not. More practically, by checking the flag reflective of the condition of the optical window 11, whether the optical window 11 is contaminated or not is determined.

When the flag is set to 1 indicating that the optical window 11 is contaminated (S110: YES), the process, in S112, displays a warning on the display unit 31 indicating that the laser sensor is contaminated. More practically, after displaying the warning of contamination of the laser sensor 10 to the user on the display unit 31, the process is concluded without performing the automatic door open control and an obstacle detection process.

When the flag is 0 indicating that the optical window is in a normal condition (i.e. no contamination) (S110: NO), the process, in S114, determines whether a vehicle speed of the vehicle is equal to 0 (i.e., 0 kilometer per hour). More practically, a vehicle speed signal is provided to the swing door ECU 30 from a vehicle speed sensor of the vehicle 2 (not illustrated), and the swing door ECU 30 determines whether the vehicle speed is equal to 0.

When the vehicle speed of the vehicle is not equal to 0 (i.e. the vehicle is not stopped) (S114: NO), the process is concluded without performing the obstacle detection process.

When the vehicle speed is equal to 0 (i.e. the vehicle is at a stop) (S114: YES), the process, in S116, determines whether the target door open angle is reached or not. The target door open angle is, in this case, a maximum door open angle when the vehicle door 20 is automatically controlled to open. Information indicative of the target door open angle is stored in EEPROM of the swing door ECU 30. The information indicative of the target door open angle may be changed to a preferred value, according to a user operation. Further, a door open angle sensor for outputting information according to an angle of door opening of the vehicle door 20 is installed in the door open and close mechanism 23. In the present embodiment, whether the vehicle door 20 reaches the target door open angle is determined based on the information indicative of the target door open angle stored in EEPROM and a signal from the door open angle sensor.

When the vehicle door 20 has already been opened to the target door open angle (S116: YES), the process is concluded without performing the obstacle detection process.

When the vehicle door 20 has not yet reached the target door open angle (S116: NO), the process, in S118, beings the door open control. In this case, the vehicle door 20 is assumed to be in a closed state. In such state, the process performs the obstacle detection process in S300.

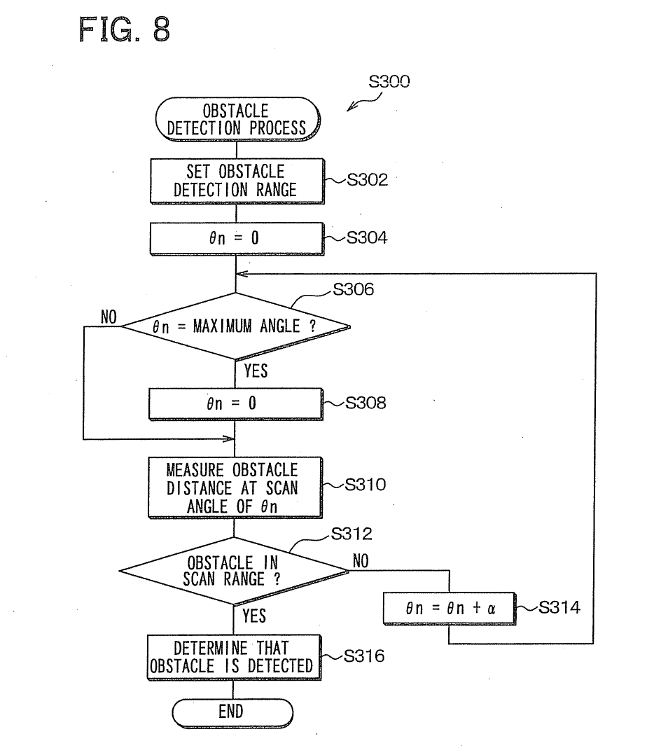

FIG. 8 shows a flowchart of the obstacle detection process. The process, in S302, first identifies an obstacle detection range. In an EEPROM of the swing door ECU 30 of the present embodiment, obstacle detection range data showing the scan range of FIG. 1 is stored. Therefore, by reading such obstacle detection range data from the EEPROM of the swing door ECU 30, the obstacle detection range is identified.

The process, in S304, sets a scan angle On to the start position (0 degree) of the scan range. Specifically, the swing door ECU 30 sends a signal to the control unit 16 for setting the scan angle On to the start position (0 degree) of the scan range. According to the signal, the control unit 16 drives the motor in the drive unit 14, so that the laser beam emitted by the LD 12 is at the start position of the scan range.

The process, in S306, determines whether the scan angle On reaches the end position (i.e., a maximum angle) of the scan range. More practically, by acquiring a signal from the scan angle detection unit 15 through the control unit 16, the process determines whether the scan angle θn reaches the end position (i.e. a maximum angle) of the scan range.

If the scan angle θn has not reached the end position (i.e., a maximum angle) of the scan range (S306: NO), the process, in S310 measures a distance to the obstacle at the scan angle θn. More practically, by emitting the laser beam from the LD 12 and receiving the reflected beam with the PD 13, the time between the emission and reception is measured and whether there is an object in the obstacle detection range is determined based on such time measurement.

When there is no object in an obstacle detection range (S312: NO), the process, in S314, updates a scan angle by adding a constant angle α to increase the scan angle θn. More practically, a signal instructing the control unit 16 to move the scan angle to θn+α is sent out. The control unit 16 drives the motor of the drive unit 14, and the emission direction of the laser beam is updated.

Then, the process returns to S306, and it performs the obstacle detection process in a state that the scan angle set to θn+α. The above described procedure is repeated until the scan angle On reaches the maximum angle. When the scan angle θn reaches the maximum angle (S306: YES), the scan angle θn is returned to the start position (0 degree) of the scan range (S308).

During the above procedure, if an object is detected in the obstacle detection range (S312: YES), the process, in S316, determines that an obstacle is detected (S316). More practically, the process sets a flag indicating that an obstacle is detected to 1, and the present process is concluded.

The process of FIG. 6 resumes at S122. That is, in S122, the process determines whether an obstacle is detected or not. More practically, whether an obstacle is detected or not is determined based on the flag indicating the obstacle detection.

When an obstacle has not been detected (i.e. the flag of obstacle detection is 0) (S122: NO), whether the vehicle door 20 reaches the target door open angle is then determined (S124).

When the vehicle door 20 has not reached the target door open angle (S124: NO), the process returns to S118. Further, in S118, the process sends out a signal to the door open and close mechanism 23, instructing to open the vehicle door 20 by a preset angle in a door open direction. Then, according to such signal, the door open and close mechanism 23 controls the vehicle door 20 to open by the preset angle in a door open direction. In such manner, while performing an automatic control of door opening, the process performs a process for detecting an object around the vehicle door 20.

When the vehicle door 20 reaches the target door open angle (S124: YES), the process concludes the door open control (S126).

Further, when an object is detected in the obstacle detection range before the vehicle door 20 reaches the target door open angle, the swing door ECU 30 warns that an obstacle has been detected, and the process concludes the door open control even if the vehicle door 20 has not yet reached the target door open angle.

Such a configuration enables the object detecting apparatus to detect the condition of the optical window 11 (i.e. is the optical window 11 contaminated) without having a separate photo-sensitive element solely dedicated for detecting contamination of the optical window 11. By changing the direction of the laser beam, such that the laser beam is emitted in a downward direction, whether or not the optical window 11 is contaminated by foreign particles (dirt, water spots, or the like) can be determined by whether the reflection of the laser beam from the surface of the pavement is detected.

Further, such a configuration for detecting contamination of the optical window 11 based on whether the time measurement between the emission and reception of the laser beam to and from the surface of the pavement is within the preset time leads to a distinctive recognition of the following three cases such as, for example, (i) contamination attached on the optical window 11, (ii) obstacle existing in the downward direction, and (iii) no obstacle existing in the downward direction.

Further, by changing the direction of the laser beam to a downward direction towards the surface of the pavement, the apparatus enables the condition detection unit to detect contamination, such as dirt or the like, on the optical window 11 before starting the automatic control of opening the vehicle door 20.

Further, such a configuration enables the swing door ECU 30 to prevent the door open and close control mechanism 23 from automatically opening and closing the vehicle door 20 when the optical window 11 is determined as being contaminated, thereby avoiding a situation that the vehicle door 20 interferes with an obstacle during opening and closing of the door as a result of the non-detection of the obstacle due to the obscurity of the laser beam caused by contamination on the optical window 11.

Further, such a configuration enables the apparatus to notify the occupant that the optical window 11 is contaminated, thereby allowing the occupant to recognize contamination of the optical window 11 and allowing the occupant to take measures, such as removing the contamination on the optical window 11.

Although the present disclosure has been fully described in connection with preferred embodiments thereof with reference to the accompanying drawings, it is to be noted that various changes and modifications will become apparent to those skilled in the art.

For example, although the above embodiment describes the operation of the object detecting apparatus based on an example of automatic door opening control of a vehicle door, the object detecting apparatus may not necessarily limited to such example, and may be applicable to a railroad vehicle, a small car, or the like.

Further, a vehicle, which may not have an automatic door opening control, may have the present object detecting apparatus. Although the present disclosure has been described with reference to a vehicle having an automatic door opening control and, although, the optical window condition detection process is performed in such object detecting apparatus, such vehicle and object detecting apparatus are used for explaining the present disclosure, and one skilled in the art would recognize that the he optical window condition detection process may be used in other apparatuses.

Further, the above example shows a situation of opening a door of the driver's seat side. However, the door may be any door, such as a passenger side door, a rear seat door, a door of a trunk or the like.

Although, in the above embodiment, the condition of the optical window is determined based on whether the time between the emission of the laser beam in the downward direction toward the surface of the pavement and the reception of the reflection beam is within the threshold, or, more practically, based on whether the distance between the laser sensor and the surface of the pavement is detected by using the laser beam is within the threshold, the condition of the optical window may be detected based on whether the reflected beam is detected when the laser beam is emitted in the downward direction.

Further, although, in the above embodiment, the contamination detection process of S200 and the obstacle detection process of S300 are performed together with other process, when the door open switch is turned on in S100, the contamination detection process and the obstacle detection process may be triggered by other operation, such as a matching of an electronic key by a key-less entry system.

Such changes, modifications, and summarized schemes are to be understood as being within the scope of the present disclosure as defined by appended claims.

In the above embodiment, S200 is equivalent to a contamination detection unit in claims. S126 is equivalent to an auto-open-close control stop instruction unit, and S112 is equivalent to a notification unit.

What is claimed is:

1. An object detecting apparatus for detecting an object around a vehicle, the apparatus comprising:
a laser sensor for emitting a laser beam through an optical window to scan in a plane by changing an emission direction of the laser beam, the laser sensor receiving a reflected laser beam through the optical window from an object positioned in the plane; and
a contamination detection unit for detecting contamination of the optical window, wherein
the contamination detection unit controls the emission direction of the laser beam in a downward direction towards a pavement surface to determine whether the optical window is contaminated based on whether the reflected laser beam from the pavement surface is received.

2. The object detecting apparatus of claim 1, wherein
the object detecting apparatus is provided in a vehicle that is equipped with a door open-close mechanism to automatically open and close a vehicle door, and
the laser sensor of the object detecting apparatus detects an object that may interfere with the vehicle door when the door is opened.

3. The object detecting apparatus of claim 1, wherein
the contamination detection unit detects contamination of the optical window based on a time period between an emission of the laser beam in the downward direction and a reception of the reflected laser beam from the pavement surface.

4. The object detecting apparatus of claim 2, wherein
the contamination detection unit changes the emission direction of the laser beam to the downward direction before starting an automatic control of opening the vehicle door.

5. The object detecting apparatus of claim 2, further including:
an auto-open-close control stop instruction unit for instructing a door open and close mechanism to stop the automatic open and close of the vehicle door when the contamination detection unit determines that the optical window is contaminated.

6. The object detecting apparatus of claim 1, further including:
a notification unit for notifying an occupant that the optical window is contaminated when the contamination detection unit determines that the optical window is contaminated.
